(19) United States
(12) Patent Application Publication
(10) Pub. No.: US 2002/0080684 A1
(43) Pub. Date: Jun. 27, 2002

(54) Large aperture vibration and acoustic sensor

(76) Inventors: Dimitri Donskoy, Hoboken, NJ (US); Keith Sheppard, Morris Plains, NJ (US)

Correspondence Address: Wolff & Samson, 5 Becker Farm Road, Roseland, NJ, 07068-1776, US

(21) Appl. No.: 09/996,037

(22) Filed: Nov. 16, 2001

Related U.S. Application Data
(60) Provisional application No. 60/249,345, filed on Nov. 16, 2000.

(51) Int. Cl. H04R 1/00

(52) U.S. Cl. 367/140

(57) ABSTRACT

A large aperture, high spatial resolution vibration and acoustic sensing device is provided. The sensor is capable of directional resolution of acoustic sources in gaseous, liquid, and solid media, and can be employed as a directional microphone or a directional hydrophone. The sensor can also be used as a high-resolution vibration displacement sensor. The device is formed of thin films comprising two electret layers and a compliant intermediate layer disposed therebetween. Conductive coatings disposed on the electret layers can be patterned and etched to provide a plurality of discrete sensing elements, forming a directional array. The sensor can be transparent, thereby allowing usage as a large area microphone disposed on top of a computer screen, video monitor, windows, or walls.

### RELATED APPLICATIONS

This application claims the priority of U.S. Provisional Patent Application Serial No. 60/249,345, filed Nov. 16, 2000, the entire disclosure of which is expressly incorporated herein by reference.

### BACKGROUND OF THE INVENTION

1. Field of the Invention

The present invention relates to devices for sensing vibration and acoustic waves, and more particularly, to a large aperture, optically transparent acoustic and vibration sensor operable to provide high spatial discrimination.

2. Related Art

Detection of sound and vibration in various media has been accomplished by a variety of means. A general reference to this field is provided by the AIP Handbook of Modem Sensors, by Jacob Fraden, American Institute of Physics, NY, 1993.

In the art one finds wide reference to the use of electret materials in microphone applications. Electrets are dielectric materials, most typically used in the form of a thin film, that can store an electrical charge. Decay of the charge varies with the material and its treatment, but charge storage can be semi-permanent in relation to measurement and/or use times. A work describing electret materials and their applications is G. M. Sessler, “Electrets” Third Ed. Vols. I and II, Laplacian Press, California, 1998.

In large measure, the application of electrets to sound sensing has involved an electret structure that incorporates an air gap. A typical electret microphone consists of a very light diaphragm and a stationary back plane that is substantially parallel to the diaphragm in an unexcited condition, and has a permanent charge implanted in an electret material to provide polarizing voltage. Sound waves impinging on the outer face of the diaphragm (typically a charged electret film) cause movement of the charged film towards the parallel back plane (which may also be implemented as a thin film), changing the capacitance of the air gap between the films. This change in capacitance is detected as a voltage output that can be amplified.

As is known, a directional reception pattern for a microphone is often needed, and such directional microphones may be implemented as an array of microphone elements. The microphone elements making up such an array will have their outputs interconnected through appropriate summation and equalization circuits, such circuits being arranged to emphasize the desired signal and attenuate signals from other sound sources in the local environment.

Although air gap electret microphones work well for small aperture areas, they have disadvantages for the larger area structures needed for directional detection using an array system. A typical problem is sagging of the electret film across the microphone area, thus creating a varying air gap. The prior art has attempted to address this problem through the use of support posts, but this approach just reduces the degree of the problem without solving it. Other efforts provide devices with varying structures, none of which provide optimal results.

### OBJECTS AND SUMMARY OF THE INVENTION

It is an object of the present invention to provide a large aperture vibration and acoustic sensor having a compliant intermediate layer sandwiched between two electrically charged layers.

It is another object of the present invention to provide an optically transparent, large aperture vibration and acoustic sensor.

It is a further object of the present invention to provide a large aperture, optically transparent vibration and acoustic sensor having high spatial resolution and directive characteristics.

It is another object of the present invention to provide a large aperture, optically transparent vibration and acoustic sensor that can be installed on a computer screen, window, or other surface, without visually obstructing same.

It is a further object of the present invention to provide a large aperture vibration and acoustic sensor having a gel-based intermediate layer disposed between electrically charged layers.

It is still another object of the present invention to provide a large aperture vibration and acoustic sensor having a silicone-based intermediate layer disposed between electrically charged layers.

It is yet another object of the present invention to provide a large aperture vibration and acoustic sensor having a charged intermediate layer that provides improved sensitivity of the sensor.

It is still a further object of the present invention to provide a large aperture vibration and acoustic sensor that is amenable to a continuous or semi-continuous manufacturing process.

The present invention relates to a large aperture vibration and acoustic sensor. The sensor of the present invention can be formed of thin films, and can be transparent to visible light. A compressible intermediate layer is positioned between and in contact with two electrically charged layers, such as electret layers. Electrodes or contacts connected to the electret layers allow the device to be connected to associated circuitry for use in sound and vibration sensing applications. One or both of the electrodes can be patterned to include a plurality of discrete sensing elements, which in turn can be connected to form a wide aperture, directional sensing array. The intermediate layer can be formed of gel and/or composite materials, allowing the intermediate layer to be compressible yet sufficiently rigid to support both electret layers. The thickness of the layers of the device can be varied to alter the characteristics of the device, and can be charged to increase sound and vibration sensing capabilities thereof. The device can be transparent and affixed to a video screen, window, or other surface. Further, the device can be used to sense sound and vibrations in gaseous, liquid, or solid media.

The device can be embodied as a directional microphone, directional hydrophone, or surface vibration sensor. The directionality pattern of the device can be driven and adjusted by associated circuitry connected to the sensor. In a liquid medium, the present invention can be utilized as a directional hydrophone and used for directional detection of sources of underwater noise such as submarines, marine mammals, etc. On solids, the device can be applied to surfaces, including large areas, and used for measurement and monitoring of structural vibrations with high spatial resolution. Such an application can be important for monitoring structural integrity or noise control.

### BRIEF DESCRIPTION OF THE DRAWINGS

Other important objects and features of the invention will be apparent from the following Detailed Description of the Invention taken in connection with the accompanying drawings in which:

FIG. 1 is a cross-sectional view of the device of the present invention.

FIG. 2 is a front view of the present invention showing an exemplary patterning of electrode structures.

FIG. 3 is a block diagram showing a exemplary circuit configuration for achieving directional sensing and steering of pattern directionality.

### DETAILED DESCRIPTION OF THE INVENTION

The present invention comprises a large aperture, thin-film device implemented in an array configuration to provide high spatial resolution sensing of sound and vibration in gaseous, liquid, and solid media. By the term vibration, what is meant is any acoustic (sound) or other type of vibration. In a preferred embodiment, the thin-film device of the invention incorporates electret materials and is implemented as an array of electret microphone elements to provide a directional microphone system. Also, optically transparent materials may be used to provide an optically transparent sensor. It should be understood that the scope of the present invention extends to any thin-film sound or vibration sensing device having the general structure and function of the described preferred embodiment.

The structure of the electret microphone array of the preferred embodiment comprises a thin-film sandwich structure that includes electrically charged layers preferably formed of electret materials. Such preferred electret materials can be polymers that are coated with a conductive material. A compliant dielectric material is positioned between and in contact with the electrically charged layers. The compliant dielectric material is selected to have a sufficiently low modulus of elasticity to allow sensitive response to pressure variations associated with sound transmission or displacements associated with vibrations in solid surfaces. The compliant layer can be a gel or one of a number of suitable polymeric or composite materials. The compliant layer may also be arranged to have electret properties and be electrostatically charged to enhance the response of the device. The charging of the compliant inner layer can be used to stabilize the electret layers of the electrodes.

Applications of the preferred embodiment include video-conferencing (e.g., sound capture from a remote location and the tracking or discrimination of speakers or sound sources), and a directional microphone for computer user interfaces via voice recognition (providing for discrimination of speakers and noise suppression and avoiding the traditional closely-spaced microphone and wire tether). Another use could be on the front window of an automobile, or any other window or surface where transparency is desired, for example, on a wall where the wallpaper or paint can be viewed through the sensor. Additional applications would include surveillance applications, both passive and active. In the latter, a tracking or immobilization device could be directed to the sound source. The invention can also be used to control voice-activated devices, including such applications as sound activation and interfacing with intelligent houses, vehicles and equipment. Further, the invention can be applied to structures to detect sounds and/or vibrations emanating therefrom, such as wings or other parts of airplanes.

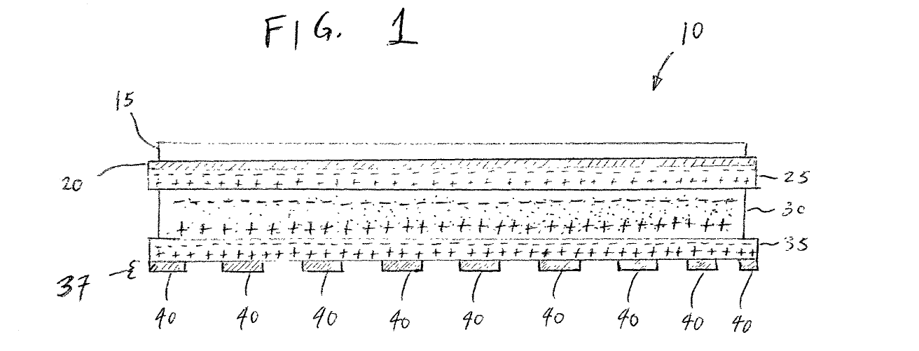

FIG. 1 is a cross-sectional view of the sensor 10 of the present invention. Electrically charged layers, such as electret layers 25 and 35 comprising the inner and outer layers of the device 10, are separated by an intermediate layer 30 that is in contact with the inner or intermediate surfaces of the electret layers 25 and 35 and is coextensive with the area of those intermediate surfaces. It is to be understood that electret layers 25 and 35 can be any electrically charged layer known in the art, such as a polarized electret or an electrostatically charged insulating material. Preferably, the electret layers 25 and 35 comprise a polymer electret. When sound waves are intercepted by the sensing device 10, the electret layers 25 and 35 of the device move with respect to each other and in response to the intercepted waves. For example, sound waves intercepted by sensing device 10 can cause electret layers 25 and 35 to move together and apart, thereby compressing and/or tensioning intermediate layer 30 and generating an output voltage corresponding to the interaction. The thickness of intermediate layer 30 can range from 10 micrometers up to several millimeters depending upon a given application.

Conductive coatings or contact layers 20 and 37 are positioned on outer or contact surfaces of electret layers 25 and 35. Discrete sensing elements 40 can be formed by patterning conductive coating 37. The conductive coating or contact layer 37 can be patterned by a subtractive process such as masking and etching procedures known in the art. Alternatively, the conductive coating can be patterned by an additive process by depositing the coating on the electret layer in a pattern. Further, the contact layer can be patterned and then positioned on the electret layer. It may be desirable to pattern one or both of the contact layers 20 and 37. Such patterning is advantageous in that the complexity and cost associated with assembly of discrete elements into an array is avoided, which helps to enable continuous or semi-continuous manufacturing. The entire thin-film device can be attached to a protective film 15.

The intermediate layer 30 can provide a degree of self-compensation for any variation in the thicknesses of the electrodes or space between the electrodes resulting from the manufacturing process. Further, intermediate layer 30 is selected to have a low elastic modulus so as to provide sufficient compliance to translate pressure changes received by the thin-film sensing device 10 to changes in separation of the two electret layers 25 and 35. An approximate calculation shows that for the pressures expected from speech in the environs of the microphone, the modulus would need to be as low as 10⁻⁴ GPa (˜15 psi) to achieve good sensitivity. This is not achievable with normal solids. Various approaches can be taken to reach the low modulus range required while still having a material that will hold its shape over an extended period. For purposes of illustration, those approaches are summarized as follows:

1. Gel materials. Gel materials are polymers that employ a limited degree of crosslinking to freeze a liquid structure. The modulus therefore can be controlled by modifying the extent of cross-linking. As the intermediate layer 30 is also required to be an electrical insulator of sufficient resistivity to prevent discharge of the electrets 25 and 35 that it separates, silicone-based gels may be used in a preferred embodiment. For transparent applications, a preferred compound is a room temperature vulcanized (RTV) silicone such as Sylgard 527, manufactured by Dow Corning.

2. Composite materials. Composite materials offer a means to further tailor the properties of the intermediate layer 30. For example, incorporation of hollow polymer microspheres into a gel can lower the modulus due to ease of compressibility. It is noted that the ease of elastic response to sound waves for such hollow polymer microspheres is the basis for use of such materials to enhance contrast in sonography of human blood flow. Such spheres have diameters of approximately 4 micrometers and are made from polyvinylidene chloride-acrylonitrile (PVC-AN) copolymer by, for example, Matsumoto Yushi Pharmaceuticals, Japan.

3. Silicone foams. Silicone foams are also a class of materials that can provide the low modulus required for non-transparent embodiments of the invention.

In a preferred embodiment of the invention, the intermediate layer 30 shown in FIG. 1 will also be polarized (poled) electrically, as indicated in FIG. 1. Polarizing enhances the electrostatic field across the structure and hence the sensitivity of the device. Such polarizing has the additional advantage of stabilizing the charges on the electret electrodes, reducing the likelihood of decay and degradation of the device.

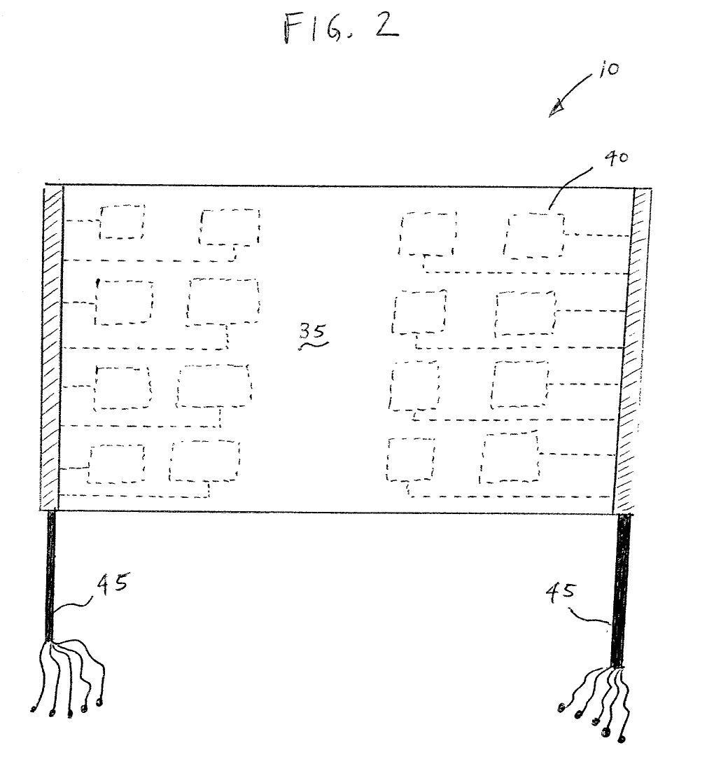

A particularly useful application of the thin film sensing device of the invention is an arrangement of a plurality of discrete microphone elements in an array configuration to form a directional microphone. FIG. 2 is a front view of an embodiment of the invention wherein discrete sensing elements 40 are arranged in an array for directional sensing. By forming the thin-film structure 10 from transparent materials, an array-based directional microphone can be made transparent. Such a transparent directional microphone could, for example, be overlaid on the screen of a computer monitor to facilitate a speech-enabled function of the computer where the speaker is discriminated from other sound sources without requiring the speaker to be tethered to a headset microphone, or the like, and without requiring other external microphone arrays.

Such a transparent embodiment of the invention would illustratively comprise a transparent insulating backing plate, which can be a rigid material such as glass or a more flexible polymeric sheet such as polymethyl methacrylate (PMMA). For a rigid structure, the thickness of the backing plate can be 100 micrometers to several millimeters. Where the microphone is to be integrated onto a substrate such as a computer video monitor screen, the backing plate can be much thinner, such as 1 to 10 micrometers, or even eliminated if the glass of the monitor screen serves as the base. This latter case can be achieved if manufacture of the monitor screen and sensor device is integrated. The backing plate 15 of FIG. 1 can be laminated with an electret material to which a thin transparent conductive coating has been applied on the side facing the backing plate. The conductive coating or contact layer in a transparent device can be made of indium tin oxide (ITO), whose resistivity is tailored to the application by control of deposition conditions. Similarly, any other transparent conductor can be used such as one made of a polymeric material. For non-transparent applications, the conductive coating can be a metal such as aluminum or copper. The thickness of the conductive coating would typically be in the range from 50 to 500 nanometers.

Electret layer 35 is employed at the outer layer of the thin-film sensing device 10 of FIG. 2. In a preferred embodiment, electret layer 35 is a thin polymeric material with typically a thickness in the range 1 to 50 micrometers, and can be one of a number of homo- or co-polymers. Typically this would be based on a fluorinated polymer. Compounds having preferred characteristics include polytetrafluoroethylene (PTFE), hexafluoropropylene (FEP), co-polymers of PTFE and FEP and substituted variants on these. Others with high resistivity include chlorotrifluoroethylene (CTFE) and ethylenetetrafluoroethylene (ETFE). Polyvinylidene fluoride (PVDF) polymer also offers attractive charge stability and resistivity and can include its co-polymers. For transparent embodiments, a preferred compound is Teflon AF manufactured by E. I. DuPont de Nemours and Company, or a similar product. Teflon AF is an amorphous copolymer of terafluoroethylene and perfluoro-2,2-dimethyl-1,3-dioxole, which provides the additional benefit of being applicable in liquid form by virtue of dissolution in fluorocarbon solvents and subsequent curing at low temperature, thus facilitating thin film coating in continuous production. Similar materials and characteristics can apply to electret layer 25.

Charging (poling) of the electret can be carried out prior to assembly into the microphone structure or as part of the assembly process. Typical charge densities for the electret following poling would be 10⁻⁸ to 10⁻⁶ C.cm⁻². A variety of charging methods are known in the art, including corona discharge methods that lend themselves to continuous manufacture of thin film structures.

The number of discrete sensing elements 40 needed to obtain directionality is dependent on the wavelengths to be detected. A minimum of two elements are required to discriminate the shortest wavelength received. For example, if the working frequency range is between 500 Hz and 3000 Hz, the respective wavelength range in air is from 0.66 m (330 m/s divided by 500 Hz) to 0.11 m. Thus, the shortest wavelength is 0.11 m. Therefore, having two elements per wavelength, the maximum spacing, d, between the elements should be no more than 0.055 m. The aperture, i.e., total length, L, of the array should be greater than the longest wavelength, λ (>0.66 m). The greater the length (the larger the aperture), the better the spatial resolution in the respective direction (it could be a 2-dimensional array). The angle beam width, α, of the directionality pattern at the commonly used 3 dB level is determined by the formula:

Alpha(−3 dB)=50(Lambda/L) degrees (1)

Contacts for discrete sensor elements 40 developed by patterning are directed to the periphery of the array wherein connection is made to the external circuitry via connections 45. In a preferred embodiment of the invention, connections 45 are formed as part of the patterning of the discrete sensor elements 40. The circuitry provides both amplification of the output and the phased array addressing to the sensor elements necessary to discriminate directionality of the sound source or spatial location of surface vibration.

Importantly, the present invention lends itself to large area, high volume manufacture using thin film processing techniques known in the art for polymeric and non-polymeric materials. For example, the electret layers of the invention can be manufactured and stored in ail rolls. They can then be charged or polarized as they are rolled onto a roll, or as they leave a roll during further processing into a device. The compliant intermediate layer can be pre-attached to one of the electret layers, or the compliant intermediate layer can be co-processed and sandwiched between the electret layers to form the multilayer device of the invention. Once the layers have been brought together, they can then be segmented to provide individual, large aperture sensing devices according to the invention. The contacts can be applied before or after segmentation.

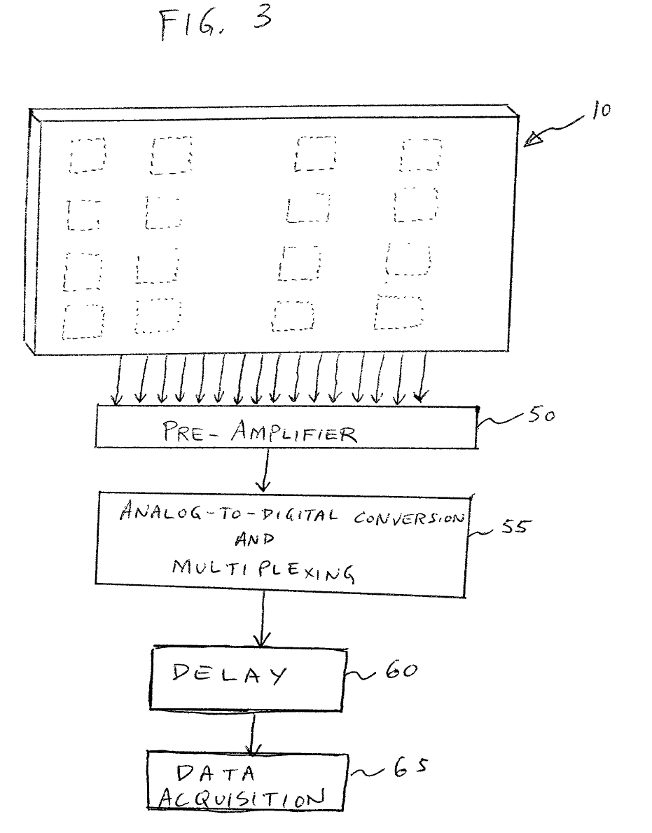

FIG. 3 is a block diagram showing an exemplary circuitry for utilizing the present invention. The thin-film sensing device 10 serves as the sound or vibration detection device. The outputs of each of the discrete sensing elements of sensing device 10 are connected to a pre-amplifier 50. It is to be understood that pre-amplifier 50 can be any amplifier known in the art. Pre-amplifier 50 amplifies output signals detected by device 10. Then, the amplified signals are sent to block 55, where they are converted from analog to digital format, and multiplexed. Once converted and multiplexed, the signals are then sent to delay block 60, and thence to data acquisition block 65. According to this configuration, sound waves received by device 10 can be analyzed and processed. For example, the direction of the sound source can be discriminated or the spatial location of a surface vibration can be determined.

Having thus described the invention in detail, it is to be understood that the foregoing description is not intended to limit the spirit and scope thereof. What is desired to be protected by Letters Patent is set forth in the appended claims.

What is claimed is:

1. An acoustic and vibration sensor comprising:
a first electrically charged layer having a contact side and an intermediate side;
a second electrically charged layer having a contact side and an intermediate side;
a compliant intermediate electrically insulating layer disposed between and contacting the intermediate sides of the first and second electrically charged layers;
a first contact layer disposed on the contact side of the first electrically charged layer; and
a second contact layer having at least one sensing element disposed on the contact side of the second electrically charged layer,
wherein the at least one sensing element and layers of the device move with respect to each other in response to acoustic or vibrational waves intercepted by the sensor, said movement creating an output voltage corresponding to said acoustic or vibrational waves.

2. The sensor of claim 1, wherein the layers comprising the sensor are optically transparent to provide an optically transparent sensor.

3. The sensor of claim 1, wherein the first contact layer comprises at least one sensing element.

4. The sensor of claim 1, further comprising a backing layer disposed on the first contact layer.

5. The sensor of claim 2, further comprising a backing layer disposed on the first contact layer wherein the backing layer comprises a computer video screen.

6. The sensor of claim 2, further comprising a backing layer disposed on the first contact layer wherein the backing layer comprises a window.

7. The sensor of claim 4, wherein the backing layer comprises a wall.

8. The sensor of claim 4, where in the backing layer comprises a surface of a structure.

9. The sensor of claim 1, wherein one or both of the contact layers can be patterned by a subtractive process to form sensing elements.

10. The sensor of claim 1, wherein one or both of the contact layers can be patterned by an additive process to form sensing elements.

11. The sensor of claim 1, wherein the intermediate layer comprises a gel.

12. The sensor of claim 1, wherein the intermediate layer comprises a composite material.

13. The sensor of claim 12, wherein the composite material further comprises a plurality of hollow polymer microspheres.

14. The sensor of claim 1, wherein at least one of the layers of the sensor is electrically polarized.

15. The sensor of claim 2, further comprising a plurality of sensing elements on the second contact layer forming a directional microphone array.

16. The sensor of claim 15, wherein directional characteristics of the sensor are adjustable by circuitry connected to the plurality of sensing elements.

17. The sensor of claim 1, wherein the length of the sensor exceeds the wavelength of the sound or vibration sensed such that the sensor comprises a large aperture sensor.

18. A method of sensing sound at a video monitor comprising:
providing a sensor having transparent layers and at least transparent one sensing element;
positioning the sensor on the transparent surface so that light emitted from the video monitor is transmitted through the sensor;
intercepting sound waves directed toward the transparent surface with the sensor;
allowing the sound waves to interact with the transparent layers and the at least one transparent sensing element; and
generating a voltage in response to interaction of the sound waves with the transparent layers and the at least one transparent sensing element, said voltage corresponding to the sound waves.

19. The method of claim 18, wherein the sensor includes a plurality of sensing elements and the method further comprises modifying directive characteristics of the sensor using control circuitry attached to a plurality of sensing elements located in the sensor.

20. A method of manufacturing a large aperture acoustic and vibration sensor comprising:
providing a first roll containing a first layer;
providing a second roll containing a second layer;
co-processing the first layer and the second layer from the first roll and the second roll;
sandwiching an intermediate layer between the first layer and the second layer to join the first layer, the intermediate layer, and the second layer together; and
applying contacts on the first layer and the second layer.

21. The method of claim 20, wherein the step of sandwiching the first and second layers comprises co-rolling the first and second layers to extrude the intermediate layer.

22. The method of claim 20, further comprising precoating the intermediate layer onto one of the first or second layers prior to co-processing the layers.

23. The method of claim 20, further comprising patterning the contacts to provide discrete sensing elements.

24. The method of claim 20, further comprising imparting an electrical charge on the first layer and second layers prior to co-processing the layers from the rolls.

25. The method of claim 20, further comprising imparting an electrical charge on the first layer and second layers after co-processing the layers from the rolls.

26. The method of claim 20, further comprising imparting an electrical charge on the intermediate layer prior to co-processing.

27. The method of claim 20, further comprising segmenting the sandwiched layers into large aperture sensors prior to applying contacts.
